(19) United States
(12) Patent Application Publication
(10) Pub. No.: US 2014/0000008 A1
(43) Pub. Date: Jan. 2, 2014

(54) Preventative 30 Day Lice Activated Headband

(71) Applicant: Barbara Santiago, Chicago, IL (US)

(72) Inventor: Barbara Santiago, Chicago, IL (US)

(21) Appl. No.: 13/914,609

(22) Filed: Jun. 10, 2013

Related U.S. Application Data
(60) Provisional application No. 61/689,593, filed on Jun. 8, 2012.

(51) Int. Cl. A01N 25/08

(52) U.S. Cl. CPC A01N 25/08
USPC 2/209.13; 424/411; 514/65; 514/531; 424/769; 514/30; 514/122; 514/747; 514/731

(57) ABSTRACT

The invention provides a specially designed headband saturated with a chemical solution that deters lice infestations. The invention provides an effective means of preventing lice from infesting the head and scalp, sparing a user the hassle and discomfort associated with eradicating lice with stringent shampoo. The Preventive 30 Day Lice Activated Headband is a gentle yet effective formula that repels lice, prevents infestations from occurring and controls the spread of lice.

### CLAIM OF PRIORITY

This patent application claims priority under 35 USC 119 (e) (1) from U.S. Provisional Patent Application Ser. No. 61/689,593 filed Jun. 8, 2012, of common inventorship herewith entitled, “Preventative 30 day Lice Activated Headband.”

### FIELD OF THE INVENTION

The present invention pertains to the field of medicinal aids, and more specifically to the field of medicated apparel to prevent infestation of head lice.

### BACKGROUND OF THE INVENTION

The prior art has put forth several designs for medicated apparel. Among these are:

U.S. Pat. No. 5,003,635 to James H. Peterson describes systems and techniques for providing insect repellent characteristics to a wide variety of wearing apparel. Elongated flexible insect repellent strips are secured to or retained in cavities in various articles of apparel to repel insects from the person wearing such apparel. The systems and techniques are applicable to all types of wearing apparel such as stockings, shoes, trousers, hats, and shirts.

U.S. Pat. No. 6,936,269 to Veronica S. Robinson describes an insect repellent substrate including a fabric base material made of felt which is impregnated with a repellent carrier composition. The carrier composition includes a mixture of wax and a naturally occurring insect repellent such as pyrethrum oil. The carrier composition also includes scented or aromatic oils such as citronella oil, rosemary oil, eucalyptus oil and neem oil. Strips of the fabric base material may be attached to headwear such as a headband or cap so that it is in contact with the wearer's hair or body. Active constituents of the carrier composition provide effective treatment and prevention of head lice and other parasitic insects.

US Patent 2007/0246059 to Vivi Aakjaer Jensen describes an accessory comprising at least two end bands which are connected with at least one connecting band, and where said end bands and said connecting band are provided as a means for decoration, treatment, measuring, or elongating or shortening said connection band.

None of these prior art references describe the present invention.

### SUMMARY OF THE INVENTION

It is an object of the present invention to provide a medicated headband for treating and preventing lice infestations.

### BRIEF DESCRIPTION OF THE DRAWINGS

FIG. 1 is a functional illustrative side view showing a person wearing a headband that provides a thirty day protective coverage from lice.

FIG. 2 is a prototypical top view of slip on cloth bands in different colors.

FIG. 3 is a functional illustrative front view showing a person wearing a headband that provides a thirty day protective coverage from lice.

FIG. 4 is a prototypical top view showing a washable slip on cloth and a stretchable and bendable plastic headband to activate the lice protection.

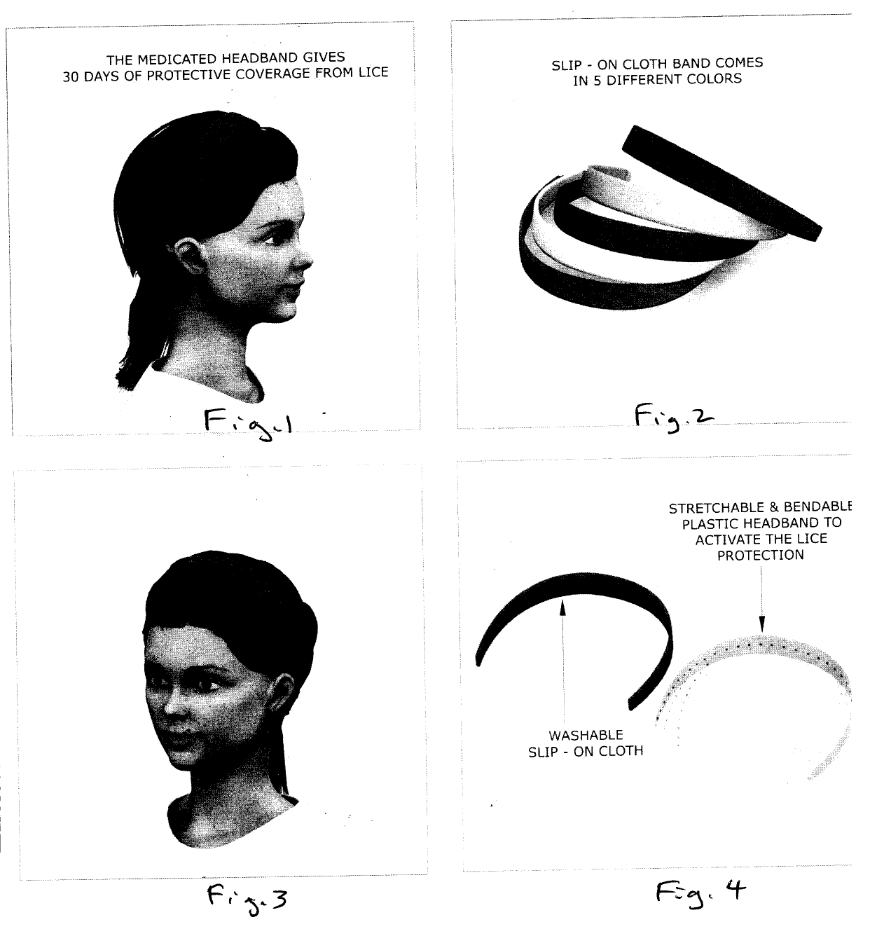

### DETAILED DESCRIPTION OF THE INVENTION

Lice are small gray insects that typically measure approximately two to three millimeters in length, live in the hair and bite the scalp, sucking the blood of the host to survive. Lice eggs or nits are oval in shape and attach along the hair shaft. Easily transferred between humans, lice are spread by using a comb or brush of an infected person or even by standing within close proximity of the infested individual. Lice can also crawl and fall onto bedding, towels, furniture and clothing, and spread rapidly throughout a home. Extremely irritating, a lice infestation is benign as far as causing disease, but lice do invoke severe itching and discomfort. The most common treatment for killing lice and nits involves shampooing dry hair with a stringent anti lice shampoo. A user vigorously massages anti lice shampoo through the shaft and scalp for a minimum of ten minutes. This treatment often requires a user to leave shampoo on their hair for an additional ten minutes to ensure all lice are eradicated. Formulated to kill living creatures, lice shampoo is extremely stringent and causes stinging, chafing and a burning sensation to the scalp. Applied to tender scalps of children, lice treatment often causes more discomfort and misery than the actual infestation.

The present invention, hereinafter referred to as the Preventive 30 Day Lice Activated Headband, is a specially designed headband saturated with a chemical solution that deters lice infestations. Design intent is to provide an effective means of preventing lice from infesting the head and scalp, sparing a user the hassle and discomfort associated with eradicating lice with stringent shampoo. The Preventive 30 Day Lice Activated Headband is a gentle yet effective formula that repels lice, prevents infestations from occurring and controls the spread of these annoying creatures. The headband design is a shape common to most headbands and measures approximately one inch in width. The base material which comprises this headband is a flexible plastic that naturally conforms to the shape of the wearer's head. The surface of the Preventive 30 Day Lice Activated Headband is coated in a specially formulated solution that repels lice and keeps them from anchoring in the wearer's scalp and hair. The specially formulated solution comprises any known head lice treatments. Known head lice treatments include, but are not limited to: tea tree oil, pyrethrin, permethrin, pyrethrum, ivermectin, malathion, Lindane, and benzyl alcohol. With continuous use, this safe medication lasts up to thirty days of continuous use. A chemical repellent reaction is activated by stretching the headband taut over one's head. Included with the Preventive 30 Day Lice Activated Headband are four easily applied decorative sheaths that are applied over the headband and provide an effective barrier between the headband and the wearer's skin. These sheaths are sized to encompass the Preventive 30 Day Lice Activated Headband completely and are available in blue, red, white, pink and purple hues. The Preventive 30 Day Lice Activated Headband is available individually or in multi count sets, with each headband individually wrapped in sterile packaging prior to use.

Use of the Preventive 30 Day Lice Activated Headband is simple and straightforward. Consumers purchase the Preventive 30 Day Lice Activated Headband for anyone who has come into contact with other people infested with lice. Application of the Preventive 30 Day Lice Activated Headband is very simple. A user removes a single headband from its protective outer wrapping and selects a protective sheath for that headband in a desired color. The user stretches the headband taut, activating a solution that coats the surface of the headband and instigating its repellent properties. The user slides the decorative colored sheath over the headband and the headband is ready for wear. The headband is worn throughout the day, warding off lice and preventing these tiny pests from taking up residence on the wearer's scalp. At the end of the day, the Preventive 30 Day Lice Activated Headband is removed from one's head. The protective sheath is removed from the headband and washed in hot soapy water. While the wet sheath air dries, the user covers the headband with one of the three remaining sheaths. This process is repeated for up to thirty days, at which point the headband and protective sheaths are discarded and replaced with a fresh Preventive 30 Day Lice Activated Headband.

The Preventive 30 Day Lice Activated Headband provides consumers with an effective noninvasive treatment that prevents lice infestations from occurring. Using the present invention effectively thwarts the spread of these tiny creatures between numerous individuals and spares others the misery associated with head lice. Easily applied and comfortable to wear, the Preventive 30 Day Lice Activated Headband provides an affordable and long lasting treatment. Affordably priced, the present invention is an invaluable commodity to millions of consumers who are regularly exposed to lice when attending school or social events with others who are harboring these irritating insects.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A medicated headband for treating and preventing lice infestations, comprising a headband saturated with a chemical solution that deters lice infestations, wherein the headband comprises flexible plastic that naturally conforms to the shape of the wearer's head, wherein the surface of the headband is in a lice repelling solution.

2. The medicated headband of claim 1 wherein the lice repelling solution includes, but is not limited to: tea tree oil, pyrethrin, permethrin, pyrethrum, ivermectin, malathion, Lindane, and benzyl alcohol.

3. The medicated headband of claim 2 wherein the headband design is a C-shape common to most headbands and measures approximately one inch in width.

4. The medicated headband of claim 3, further comprising an easily applied decorative sheath applied over the headband and provide an effective barrier between the headband and the wearer's skin.

5. The medicated headband of claim 4 wherein the decorative sheath encompasses the headband completely and is available in blue, red, white, pink and purple.
